(19) United States
(12) Patent Application Publication
(10) Pub. No.: US 2025/0128536 A1
(43) Pub. Date: Apr. 24, 2025

(54) FOUNTAIN PEN

(71) Applicant: Joel Conrade Mayer, Cambridge (CA)

(72) Inventor: Joel Conrade Mayer, Cambridge (CA)

(21) Appl. No.: 18/489,965

(22) Filed: Oct. 19, 2023

(51) Int. Cl. B43K 5/18; B43K 5/00; B43K 5/06; B43K 5/10

(52) U.S. Cl. CPC B43K 5/1818; B43K 5/005; B43K 5/06; B43K 5/10

(57) ABSTRACT

A fountain pen that is configured to be reloaded with ink wherein the fountain pen of the present invention has an improved volume capacity over conventional fountain pens. The invention includes a body wherein the body includes a grip portion and a barrel portion that are rotatably coupled. A nib is secured to the first end of the body. A rod member is mounted within the interior volume of the body and extends the length thereof. A piston head member is operably coupled to the rod member and is configured to traverse therealong during rotation of the barrel portion of the body. The wall member of the barrel portion of the body includes movement members formed thereon. The perimeter edge of the piston head member is sealably and operably coupled with the movement members and wherein movement of the piston head member facilitates the drawing of ink into the body.

### FIELD OF THE INVENTION

The present invention relates generally to writing instruments, more specifically but not by way of limitation, a fountain pen wherein the fountain pen of the present invention is configured to employ a movable piston head member to facilitate the refilling of ink in the fountain pen.

### BACKGROUND

As is known in the art, the development of the fountain pen precipitated from the inconvenience of having to repetitively dip a pen in ink to replenish the pen while writing. The original fountain pen was invented by Romanian inventor Petrache Poenaru in approximately 1827. In 1844 Lewis Waterman developed an improved version of the fountain pen having a three channel ink feed which led to smoother writing performance and is commonly given credit for development of the modern fountain pen.

Fountain pens are configured to be reloaded with ink wherein most fountain pens employ a movable piston that draws the ink into the ink reservoir in the pen and facilitates the flow of ink during writing. The issue with conventional fountain pens is the movable piston utilizes a conventional design wherein the piston includes a piston head operably coupled to a piston rod. The piston rod inhibits the travel distance of the piston head and as such limits the capacity of the amount of ink that can be stored within the pen.

Accordingly, there is a need for a fountain pen that is configured to employ a rod free piston-like element that is movably mounted within the interior of the fountain pen so as to facilitate the loading of a greater volume of ink.

### SUMMARY OF THE INVENTION

It is the object of the present invention to provide a fountain pen that is configured to be reloaded with ink wherein the fountain pen includes a body having a grip portion and a barrel portion.

Another object of the present invention is to provide a reloadable fountain pen wherein the grip portion and barrel portion are rotatably coupled and further being contiguous.

A further object of the present invention is to provide a fountain pen that is configured to be reloaded with ink wherein the interior surface of the barrel portion includes threads or similar element disposed thereon.

Yet a further object of the present invention is to provide a reloadable fountain pen wherein the body of the pen includes a rod member disposed within the interior volume wherein the rod member extends substantially the length of the body of the fountain pen.

Still another object of the present invention is to provide a fountain pen that is configured to be reloaded with ink wherein the rod member has movably coupled thereto a piston head member.

An additional object of the present invention is to provide a reloadable fountain pen wherein the piston head member is configured to traverse in an upwards-downwards direction along the rod member.

Yet a further object of the present invention is to provide a fountain pen that is configured to be reloaded with ink wherein the interior volume of the body of the pen is configured to be substantially filled with ink.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a cross-sectional diagrammatic view of the present invention.

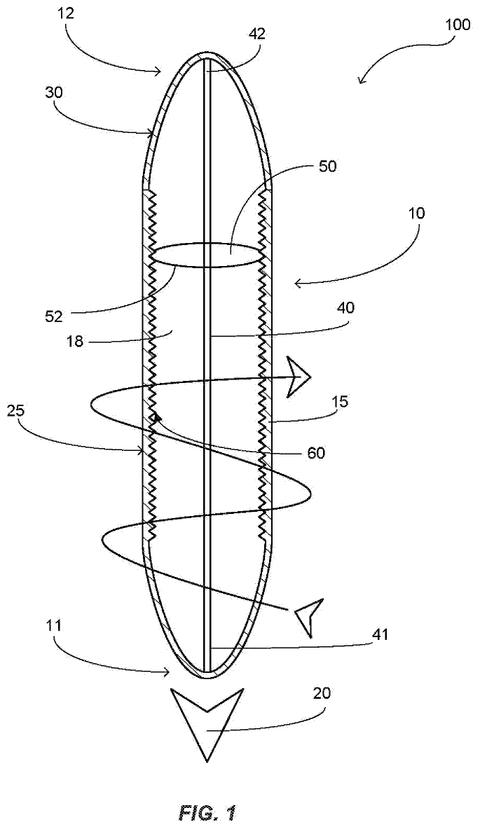

### DETAILED DESCRIPTION

Referring now to the drawings submitted herewith, wherein various elements depicted therein are not necessarily drawn to scale and wherein through the views and figures like elements are referenced with identical reference numerals, there is illustrated a fountain pen 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the fountain pen 100 includes a body 10 wherein the body 10 is generally cylindrical in shape having a first end 11 and second end 12. The body 10 is manufactured from a durable rigid material such as but not limited to metal. Body 10 includes wall member 15 defining an interior volume 18 wherein a portion of the interior volume 18 is operable to receive and retain ink as described further herein. Operable coupled to the first end 11 is nib 20 wherein the nib 20 is a conventional nib and configured to dispense ink therefrom.

The body 10 is comprised of a barrel portion 25 and a grip portion 30 wherein the barrel portion 25 and grip portion 30 are rotatably coupled utilizing suitable techniques. The interior volume 18 has mounted therein a rod member 40. Rod member 40 includes a first end 41 and a second end 42 wherein the first end 41 is secured to the interior surface of the wall member proximate the first end 11. The second end 42 of the rod member 40 is secured to the interior surface of the wall member 15 proximate the second end 12 of the body 10. The rod member 40 extends the length of the interior volume 18 of the body 10.

Movably coupled to the rod member 40 is piston head member 50. Piston head member 50 is annular in shape and is operable to move along the rod member 40 intermediate the first end 11 and second end 12 in an upwards-downwards movement. The piston head member 50 includes perimeter edge 52 wherein the perimeter edge 52 is sealably and operably coupled with the movement members 60 formed on the interior surface of the wall member 15. The movement members 60 are formed on the interior surface of the wall member 15 in the barrel portion 25. As the barrel portion 25 is rotated with respect to the grip portion 30, the piston head member 50 will traverse within the barrel portion 25 along the rod member 40 in a direction that is dictated by the rotational movement of the barrel portion 25. In one embodiment of the present invention, the movement members 60 are thread like formations that are sized to operably engage the perimeter edge 52 and facilitate traversal of the piston head member 50 in an upwards-downwards direction.

While thread-like members have been illustrated and discussed herein, it should be understood within the scope of the present invention that the movement members 60 could be constructed in alternate manners in order to facilitate movement of the piston head member 50 in an upwards-downwards direction. During rotation of the barrel portion 25, with the nib 20 being submerged in an ink reservoir, the piston head member 50 being sealably coupled to the interior surface of the wall member 15 will facilitate the drawing of ink into the interior volume 18 wherein the volume of ink is greater than a traditional fountain pen as the piston head member 50 can travel a greater distance within the body 10 as a result of the construction thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A fountain pen comprising:
a body, said body being generally cylindrical in shape, said body having a first end and a second end, said body having a wall member defining an interior volume, said interior volume of said body being substantially hollow, said body having a barrel portion extending from said second end and a grip portion extending from said first end, said barrel portion and said grip portion being rotatably coupled;
a non-rotating rod member, said rod member being mounted within the interior volume of said body, said rod member having a first end and a second end, said first end of said rod member being secured to an interior surface of said wall member of said body proximate said first end of said body, said second end of said rod member being secured to an interior surface of said wall member proximate said second end of said body;
a piston head member, said piston head member being operably coupled to said rod member, said piston head member having a perimeter edge, said perimeter edge of said piston head member being sealably coupled to an interior surface of said wall member along said barrel portion; and
a movement member, said movement member being formed on the interior surface of the wall member within said barrel portion, said movement member being operably coupled to said piston head member,
wherein rotation of said barrel portion of said body facilitates movement of the piston head member along said rod member to both withdraw ink into the body via the first end and dispense ink from the body via the first end.

2. The fountain pen as recited in claim 1, wherein said rod member extends longitudinally within the interior volume of the body from the first end of said body to said second end of said body.

3. The fountain pen as recited in claim 2, wherein said piston head member is annular in shape.

4. The fountain pen as recited in claim 3, wherein said movement member is a thread-like structure formed on said interior surface of said wall member.

5. (canceled)

6. The fountain pen as recited in claim 5, and further including a nib, said nib being secured to said first end of said body.
